(19) United States
(12) Patent Application Publication
(10) Pub. No.: US 2006/0195533 A1
(43) Pub. Date: Aug. 31, 2006

(54) Information processing system, storage medium and information processing method

(75) Inventors: Takashi Isozaki, Kanagawa (JP); Kazunaga Horiuchi, Kanagawa (JP); Hirotsugu Kashimura, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/210,904

(22) Filed: Aug. 25, 2005

(30) Foreign Application Priority Data
Feb. 28, 2005 (JP) 2005-054500

(51) Int. Cl. G06F 15/16

(52) U.S. Cl. 709/206

(57) ABSTRACT

An information processing system including: a sender information holding unit that stores an email address of a sender of an email in correlation with one of a plurality of sender categories; and an importance level estimation unit that determines, for each of the plurality of sender categories, importance levels of emails having sender addresses that belong to each of the plurality of sender categories from a plurality of importance level categories, while employing information of emails previously received by a user, and designates the importance levels in correlation with the sender categories; wherein information of the importance level categories obtained by the importance level estimation unit is subjected to a predetermined process.

### BACKGROUND OF THE INVENTION

1. Field of the Invention

The present invention relates to an information processing system, a storage medium, and an information processing method for processing email.

2. Description of the Related Art

Recently, since the use of email for communication has become common and an enormous number of email messages are being exchanged by users on a daily basis, a technique is demanded whereby important information can be extracted from the contents of a large quantity of email messages and selectively presented to users. In response to this demand, various information processing systems have been proposed for determining the importance levels of email message contents and for presenting information to users.

The following example methods have been developed: a method (see JP-A-11-154975) for determining whether email received from a predetermined address, or email in which a predetermined password is included, is important; a method (see JP-A-2000-163336) for determining an importance level in correspondence with the number of simultaneous recipients of an email message; and a method (see JP-A-2000-172580) whereby a sender can transmit an email message to which importance level information and payment period information have been added in order to update a recipient's importance level information. However, while these methods are effective in specific situations, such as when passwords are employed on both sides or when simultaneous recipients are present, importance levels cannot be determined for general users for which determination references vary.

There are other methods whereby the importance level for a newly received email message can be determined based on email previously received by an individual user. For example, the following methods have been proposed: a method (see JP-T-2002-529820) whereby the response by a user is monitored relative to email received in the past, and by employing the monitoring result information, the email message is classified in accordance with Bayesian networks; and a method (see JP-T-2004-506961) whereby, based on a clear instruction received from a user or a response by a user to an email message, email is classified using Bayesian statistics or Bayesian networks or a support vector machine.

In order to apply these methods, however, the importance levels of email messages previously received by a user must be evaluated in some way, and the results should be employed as basic information for determining the importance level for a newly received email message.

### SUMMARY OF THE INVENTION

As described above, according to the conventional techniques, human labor is required to collect basic information, e.g., a user clearly enters an evaluation of the importance level for an email message received in the past. So long as the requisite basic information is collected by monitoring the user's response to the email message, this labor can be eliminated. However, to increase the accuracy of the determination of the importance level, a large amount of information must be collected for an extended period of time, and for this the work efficiency is low.

Furthermore, assume that email messages a user previously received are employed to provide basic information for determining the importance levels for email messages transmitted by all senders. For an email message received from a new sender with whom the user has never previously exchanged email, since no prior email information is available for that sender, the importance level for the current email message cannot be determined.

To resolve these shortcomings, the present invention provides an information processing system, a storing medium, and an information processing method for increasing work efficiency without labor being required of a user, and for determining an importance level for an email message while taking into account the email message was received from a new sender.

According to one aspect of the invention, there is provided an information processing system including: a sender information holding unit that stores an email address of a sender of an email in correlation with one of a plurality of sender categories; and an importance level estimation unit that determines, for each of the plurality of sender categories, importance levels of emails having sender addresses that belong to each of the plurality of sender categories from a plurality of importance level categories, while employing information of emails previously received by a user, and designates the importance levels in correlation with the sender categories; wherein information of the importance level categories obtained by the importance level estimation unit is subjected to a predetermined process.

According to another aspect of the invention, there is provided an information processing method performed by an information processing system, which includes a sender information holding unit that stores an email address of a sender of an email in correlation with one of a plurality of sender categories, the method including: determining, for each of the plurality of sender categories, importance levels of emails having sender addresses that belong to each of the plurality of sender categories from a plurality of importance level categories, while employing information of emails previously received by a user; and designating the importance levels in correlation with the sender categories; wherein information of the importance level categories thus obtained is subjected to a predetermined process.

According to still another aspect of the invention, there is provided a storage medium readable by a computer, the storage medium storing a program of instructions executable by the computer, which includes a sender information holding unit that stores an email address of a sender of an email in correlation with one of a plurality of sender categories, to perform a function including: determining, for each of the plurality of sender categories, importance levels of emails having sender addresses that belong to each of the plurality of sender categories from a plurality of importance level categories, while employing information of emails previously received by a user; and designating the importance levels in correlation with the sender categories; wherein information of the importance level categories thus obtained is subjected to a predetermined process.

According to the invention, an email message is classified in accordance with its importance level category by using the sender category that is correlated with the email address of the sender. Thus, without requiring any labor of a user, information for determining the importance level for an email message can be collected efficiently. For an email message transmitted by a new sender, the importance level thereof can be determined in the same manner as for an email message received from a known sender.

### BRIEF DESCRIPTION OF THE DRAWINGS

Embodiments of the present invention will be described in detail based on the following figures, wherein:

FIG. 1 is a functional block diagram showing an information processing system according to one embodiment of the present invention;

FIG. 2 is a functional block diagram showing a sender classification unit of the information processing system according to the embodiment of the invention;

FIG. 3 is a functional block diagram showing an importance level estimation unit of the information processing system according to the embodiment of the invention; and

FIG. 4 is a diagram showing example information stored in an importance level category determination reference database of the information processing system according to the embodiment of the invention.

### DETAILED DESCRIPTION OF THE INVENTION

An embodiment of the present invention will now be described in detail while referring to the drawings. An information processing system according to the embodiment of the invention can serve as an information processing apparatus, such as a personal computer, a portable information terminal or a server computer, or can be constituted by a plurality of information processing apparatuses connected via a network. Furthermore, the processing performed by the information processing system may be performed by a software program, which may be provided via a computer-readable storage medium, or through communication performed via a network, and which may be performed by the above described information processing apparatus.

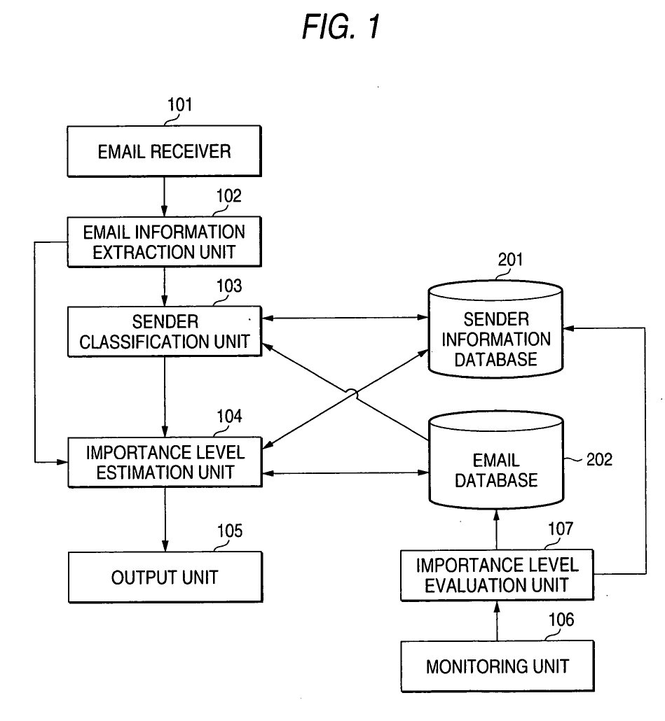

As shown in a functional block diagram in FIG. 1, the information processing system for this embodiment of the invention comprises: an email receiver 101; an email information extraction unit 102; a sender classification unit 103; an importance level estimation unit 104; an output unit 105; a monitoring unit 106; an importance level evaluation unit 107; a sender information database 201; and an email database 202. The email information extraction unit 102, the sender classification unit 103, the importance level estimation unit 104 and the importance level evaluation unit 107 can be provided by a CPU and a processing program that use data stored in a storage device such as a RAM (Random Access Memory) or a ROM (Read Only Memory). The sender information database 201 and the email database 202 are stored in a storage device such as a RAM or a hard disk drive.

The email receiver 101 is a network card or a modem that receives an email message transmitted across a network and outputs the email message to the email information extraction unit 102. The email information extraction unit 102 extracts a sender address and other information from the header portion of the email message received from the email receiver 101. The email information extraction unit 102 also extracts from the main body of the email information concerning whether a predetermined keyword, which is used to determine the sender category and the importance level, is present in the main body of the email message, and information concerning how many specific characters, often used in an email message for advertising, are included in the main body. The sender classification unit 103 and the importance level estimation unit 104 respectively employ the information extracted by the email information extraction unit 102 to classify the sender address of the email and to prepare an importance level estimate for the email message.

The sender classification unit 103 classifies the sender address of the received email message using a plurality of sender categories obtained based on information stored in the sender information database 201 and the email database 202, and information obtained by the email information extraction unit 102. The process performed by the sender classification unit 103 will be explained in detail later.

The importance level estimation unit 104 determines the importance level for the received email message by selecting one of a plurality of importance level categories, based on information stored in the sender information database 201 and the email database 202 and on information obtained by the email information extraction unit 102 and on information for the sender category obtained by the sender classification unit 103. The process performed by the importance level estimation unit 104 will be described in detail later.

The output unit 105 is, for example, a display unit, a loudspeaker or a communication device connected to the network, and outputs information for the received email message along with information for the importance level category obtained by the importance level estimation unit 104. Through this processing, only important email messages will be displayed on the screen of the information processing apparatus, or email messages will be arranged and displayed, in the ascending order of their importance levels, on the display of the information processing apparatus. Further, when an email message having a high importance level is received, notification for a user can be provided by a popup display, the output of an alarm, or the transfer of the email message to a portable information terminal. The contents of the process, consonant with the importance level and the range of the importance level to be processed, may be designated by the user.

The monitoring unit 106 includes a program for recording a user operation for the information processing apparatus, and a sensor or a camera, and monitors a user response related to the received email. By recording the user operation performed by the information processing apparatus, the process performed by the user for the received email message can be monitored. Example processes performed by the user are the selection of the email message using software for processing email, the display of the email message on the screen for a predetermined period of time, the printing or the deletion of the email, or the transmission of a reply to the email or the transmission of an email message to be transferred to a third party. When one of these processes is detected, information as to the date of the performance of the process, the number of times the process was performed, the speed at which the operation was entered in the information processing apparatus, and information as to whether the pertinent process was performed with another process can also be recorded. Moreover, by using a sensor or a camera, the period during which the user remained in front of the information processing apparatus and whether or not the user uttered anything may be monitored.

The importance level evaluation unit 107 evaluates the importance level for received email based on the information obtained by the monitoring unit 106 and information specifically entered by the user. An evaluation method can be a method for determining a condition simply by employing a threshold value for a monitoring item, or a method for employing Bayesian statistics or Bayesian networks or a support vector machine. The importance level evaluation unit 107 employs the obtained evaluation results to update the information stored in the email database 202 and the sender information database 201.

Information concerning the addresses of email messages transmitted and received by the user in the past is stored in the sender information database 201. Example accumulated information concerning email addresses is information for sender categories that were predesignated or that were previously classified by the sender classification unit 103, information for the number of email messages the user received from each address in the past, and information for the importance level category that the importance level estimation unit 104 or the importance level estimation unit 107 determined for an email message transmitted from the pertinent address in the past. The sender classification unit 103 and the importance level estimation unit 104 employ these data, together with information stored in the email database 202.

The history of the email messages the user transmitted and received in the past and the information extracted from the email messages are stored in the email database 202. For the email messages, information for the importance level categories determined by the importance level estimation unit 104 or the importance level evaluation unit 107 is also stored in the email database 202. These data are employed by the sender classification unit 103 and the importance level estimation unit 104, together with information stored in the sender information database 201.

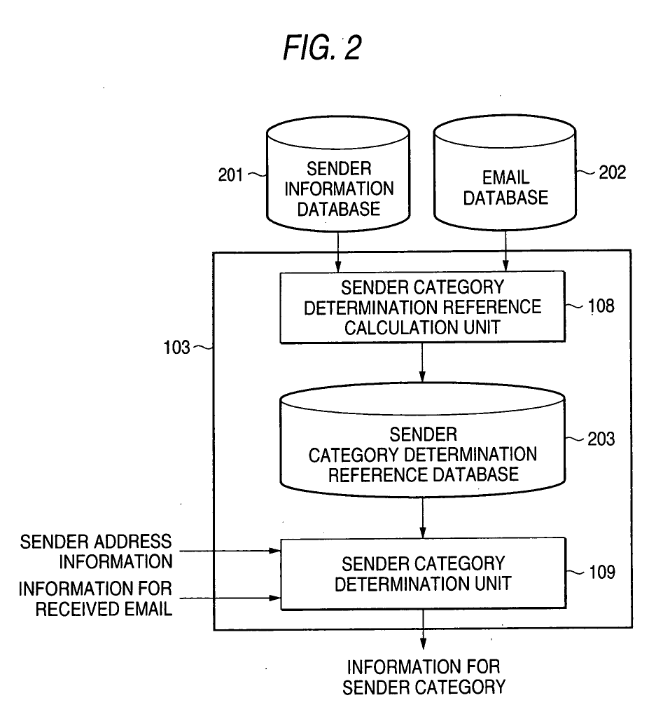

The contents of the processing performed by the sender classification unit 103 will now be explained in detail. As shown in a functional block diagram in FIG. 2, the sender classification unit 103 includes a sender category determination reference calculation unit 108, a sender category determination unit 109 and a sender category determination reference database 203. The sender category determination reference calculation unit 108 and the sender category determination unit 109 can be provided, for example, by a CPU and a processing program stored in a storage device such as a RAM or a ROM. The sender category determination reference database 203 is stored in a storage device such as a RAM or a hard disk drive.

The sender category determination reference calculation unit 108 employs information stored in the sender information database 201 and the email database 202 to determine information to be used as a determination reference for classifying a sender address for one of the sender categories. Specifically, multiple sets of determination conditions are predesignated for sender addresses of email messages and their contents, and the sender category determination reference calculation unit 108 calculates information to determine which sender category matches the sender address and the contents of the received email message that are pertinent to one set of determination conditions. A calculation method can be a method employing Bayesian statistics, Bayesian networks, a support vector machine or a co-occurrence pattern.

When Bayesian statistics or Bayesian networks is employed, the sender category determination reference calculation unit 108 calculates a conditional probability whereat the address of a sender that matches one specific set of determination conditions is pertinent to each of the sender categories, and outputs the results. To perform this calculation, for email messages transmitted in the past, the sender category determination reference calculation unit 108 employs information representing a correlation between the determination conditions and the sender categories to which the addresses of the senders of the email messages belong.

The determination conditions that are used for determining a sender category and that are based on the address of the sender are: the character string of the address of the sender, the sender category classification of the address of the sender in the past; the number of email messages the user transmitted to and received from the address of the sender in the past; and the importance level categories of the email messages received from the address of the sender in the past.

The determination conditions that are used for determining a sender category and that are based on the email received from the address of the sender that belongs to the sender category are: the number of simultaneous recipients of the email; the presence/absence of an attached file; the number of characters in the main body; the number of specific characters included in the title and the main body of the email; the presence/absence of a keyword, concerning a conference, a date, an appointment, a payment, an advertisement or a news item, included in the title and in the main body, and the number of times the keyword was entered; the presence/absence of salutations and polite expressions, and the types of words employed; and the results obtained by performing natural language processing for the title and the main body. Furthermore, when a file is attached to the email, the type, the size and the file name of the attached file can also be employed as determination conditions. When the email is transmitted to a recipient other than the user, information concerning the sender category of the email address of the pertinent addressee can also be employed. As well as the received email, email that the user transmitted in the past to the address of the sender that belongs to the sender category can be employed as a determination condition.

Further, by weighting performed using dates whereat email messages were transmitted and received in the past, a determination condition can be calculated based on these email messages. Thus, the calculation of the determination is possible while placing more emphasis on information for email messages transmitted and received recently.

Furthermore, as a fixed determination condition, a predesignated condition can be employed without depending on the above calculation. For example, the sender address for an email that includes a specific keyword in its main body always receives a specific sender category classification.

Information indicating a correlation between a set of determination conditions that is determined by the sender category determination reference calculation unit 108 and the sender category is stored in the sender category determination reference database 203. The sender category determination reference calculation unit 108 may update the sender category determination reference data base 203 each time a new email message is received, each time the count of email messages received reaches a predetermined number, or each time a predetermined period of time elapses. The range for the updating may be the entire database 203, or may be a portion that concerns only the newly received email message.

When new email is received, the sender category determination unit 109 employs the email sender address, and information extracted from the email, to identify which set of determination conditions stored in the sender category determination reference database 203 the address of the sender matches, and determines a corresponding sender category. The information for the determined category sender is reflected in the sender information database 201, and is employed for the succeeding process performed by the importance level estimation unit 104. Or, as described in “Expert Systems and Probabilistic Network Model”, E. Castillo, J. M. Gutierrez and A. S. Hadi, Springer-Verlag New York, Inc., 1997, a conditional probability whereby the sender address is classified for each sender category may be calculated, for example, by using the Baysian network probability calculation method stored in the sender database 201, and may be employed as a propagation probability for the succeeding process performed by the importance level estimation unit 104. In this case, the sender category determination reference calculation unit 108 and an importance level category determination reference calculation unit 110 may employ the same Baysian network.

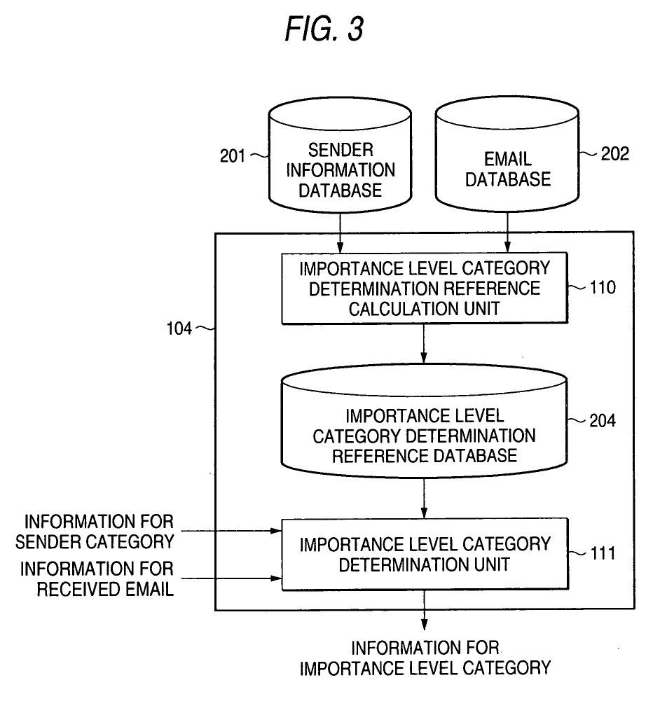

The contents of the processing performed by the importance level estimation unit 104 will now be described. As shown in a functional block diagram in FIG. 3, the importance level estimation unit 104 includes the importance level category determination reference calculation unit 110, an importance level category determination unit 111 and an importance level category determination reference database 204. The importance level category determination reference calculation unit 110 and the importance level category determination unit 111 can be provided, for example, by using a CPU and a processing program stored in a storage device such as a RAM or a ROM. The importance level category determination reference database 204 is held in a storage device such as a RAM or a hard disk drive.

The importance level category determination reference calculation unit 110 employs information stored in the sender information database 201 and in the email database 202 to determine which information is to be used as a determination reference to obtain the importance level for email. Specifically, multiple sets of determination conditions are predesignated concerning the contents of an email message and sender categories that are correlated with the addresses of the senders of email messages, and the importance level category determination reference calculation unit 110 calculates information to determine which importance level category matches this sender category and the contents of the received email pertinent to one set of determination conditions. A calculation method can be a method that employs Bayesian statistics or Bayesian networks, a support vector machine or a co-occurrence pattern. When the same method as used by the sender category determination reference calculation unit 107 is employed, both units can be constituted as a common program routine.

When Bayesian statistics or Bayesian networks is employed, the importance level category determination reference calculation unit 110 calculates a conditional probability at which email matching a set consisting of a specific sender category and a determination condition is pertinent to each of the importance level categories, and outputs the obtained results. For this calculation, the importance level category determination reference calculation unit 110 employs information indicating a correlation between the set consisting of the sender category and determination conditions and the importance levels for email messages received in the past.

For the determination of the importance level category, the determination conditions used by the sender category determination reference calculation unit 108 can be employed. In addition, the title of email and information as to whether a specific importance level related keyword is included in the main body can also be employed.

Information concerning multiple sets of determination conditions, which is determined by the importance level category determination reference calculation unit 110, and the importance level category is stored in the importance level category determination reference database 204. The importance level category determination reference calculation unit 110 may update the importance level category determination reference database 204 each time a new email message is received, each time the count of email messages received reaches a predetermined number, or each time a predetermined period of time elapses. The range for the updating may be the entire database 204, or may be a portion that concerns only the newly received email message.

When new email is received, the importance level category determination unit 111 employs the sender category of the email and information extracted from the email to identify a set of determination conditions held in the importance level category determination reference database 204 with which the email is matched, and determines a corresponding importance level category. The information for the determined importance level category is reflected in the sender information database 201 and the email database 202, and is employed by the output unit 105 to determine a method for outputting email.

An explanation will now be given for the contents of the processing performed when an unknown sender has transmitted email to a user while employing the information processing system according to the embodiment of the invention. For this processing, assume that the email is transmitted by a new colleague of the user at the company whereat the two work, that the sender address is “aaa@bbb.co.jp” and that the main body of the email includes a character string representing the name of the department the user belongs to and the character string “conference”.

First, the email receiver 101 receives an email message and transmits the contents to the email information extraction unit 102. The email information extraction unit 102 extracts from the contents of the received email message information indicating that the sender address is “aaa@bbb.co.jp”, and that the predetermined characters and the predetermined keyword are included in the main body of the email.

The sender classification unit 103 then determines a sender category classification for the sender address. At this time, the sender address, “aaa@bbb.co.jp”, has not yet been registered in the sender information database 201 because the user has not previously received email from the sender. Thus, the sender classification unit 103 performs a sender category determination process based on information obtained by the email information extraction unit 102.

The sender classification unit 103 holds, in the sender category determination reference database 203, the results obtained by the sender category determination reference calculation unit 108 based on the information stored in the sender information database 201 and the email database 202. In this case, assume that, when character string “bbbb.co.jp” is included in the email address and when the same character string as the name of the department the user belongs to is included in the main body of the email, a determination reference to the effect that the pertinent sender address probably falls within the sender category “boss or colleague” is held. In accordance with this determination reference, the sender category determination unit 109 obtains determination results indicating that sender address “aaa@bbb.co.jp” belongs to the sender category “boss or colleague”. The obtained results are output to the importance level estimation unit 104 and are also stored as information for anew sender address in the sender information database 201.

Sequentially, the importance level estimation unit 104 prepares an importance level estimate for the received email. Specifically, based on the information for the sender category obtained by the sender classification unit 103 and the information for the email obtained by the email information extraction unit 102, the importance level estimation unit 104 determines to which category, of multiple importance level categories, the received email belongs.

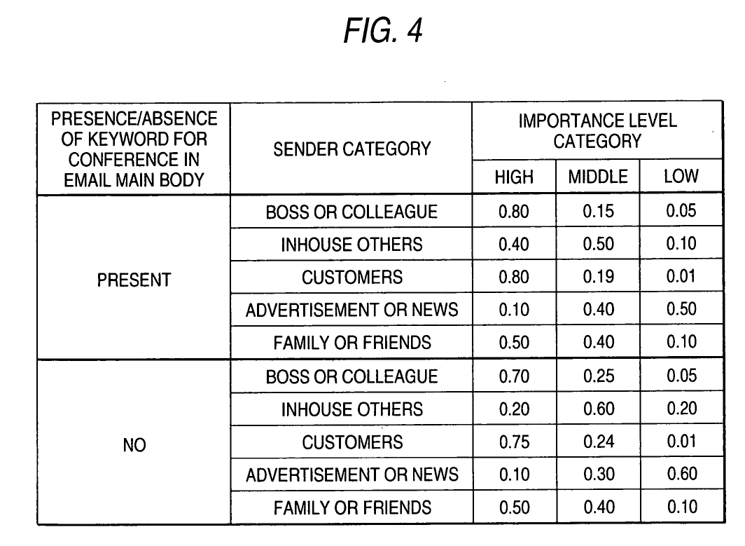

The importance level estimation unit 104 holds, in the importance level category determination reference database 204, the results that the importance level category determination reference calculation unit 110 has obtained, based on the information stored in the sender information database 201 and the information stored in the email database 202. In this embodiment, assume that, depending on whether a keyword for conference is included in the main body of the email and which sender category the email belongs to, multiple sets are prepared and probabilities that the individual multiple sets are pertinent to individual importance level categories are calculated, and the obtained result is held as a determination reference example, as shown in FIG. 4. As for the currently received email, since the main body includes the character string “conference”, which is a keyword for a conference, and the sender category is “boss or colleague”, the probability that the importance level category will be “high” is 0.8, which is the highest. Thus, the importance level category determination unit 111 determines that the importance level category for the pertinent email is “high”.

Based on the thus obtained results and in accordance with the information that the importance level category of the received email is “high”, the output unit 105 outputs the information for the email.

According to the embodiment of the present invention, the importance level can be appropriately determined for email received from an email address unknown to the user.

An explanation will now be given for the contents of the processing performed when an email is transmitted to a user by a sender already known to the information processing system according to the embodiment of the present invention. In this case, an email message was transmitted by a person, a company colleague of the user, who was transferred to a different department, and the sender address is “ccc@bbb.co.jp”.

First, as well as when an email message is transmitted by an unknown sender, the email receiver 101 receives the email message and the email information extraction unit 102 extracts information from the message.

The sender classification unit 103 determines a sender category classification for the address of the sender. In this case, since the address “ccc@bbb.co.jp” belongs to a company colleague of the user, information pertinent to sender category “boss or colleague” is held in the sender information database 201. However, in order to determine whether the sender category is appropriate, the sender classification unit 103 again performs a sender category determination process.

The sender classification unit 103 holds, in the sender category determination reference database 203, the results obtained, based on the information stored in the sender information database 201 and the information stored in the email database 202, by the sender category determination reference calculation unit 108. In this case, assume that a determination reference is obtained based on whether character string “bbbb.co.jp” is included in the email address, on the number of email messages exchanged by the user and the pertinent sender during a recent, predetermined period of time, and information about the importance level categories of the email messages that were received. Since the number of email messages exchanged with the sender is reduced because the sender was transferred, and since the determination results obtained for the importance level categories of the received email messages are also lowered, it is determined that the address “ccc@bbbb.co.jp” belongs to the sender category “inhouse others”. The obtained results are output to the importance level estimation unit 104 and are employed to update information concerning the address of the sender in the sender information database 201.

Following this, the importance level estimation unit 104 provides an estimated importance level for the received email. When a keyword included for a conference is not present in the email, in accordance with information held in the importance level category determination reference database 204 in FIG. 4, the probability is the highest that the importance category will be “high” when the address of the sender belongs to sender category “boss or colleague”, while the probability is the highest that the importance category will be “middle” when the address of the sender belongs to sender category “inhouse others”. Therefore, based on the information for the new sender category “inhouse others”, the importance level category for the pertinent email is determined to be “middle”.

Based on the thus obtained results and in accordance with information that the importance level category for the received email is “middle”, the output unit 105 outputs information for the email.

According to the above described embodiment of the present invention, when email is received from an email address previously known to a user, the sender category is reviewed based on the frequency at which email is exchanged by the user and the sender, while when the social relationship has changed, the importance level for the email can appropriately be determined based on changes in the contents of email messages.

In this embodiment, five sender categories have been employed: “boss or colleague”, “inhouse others”, “customers”, “advertisement or news” and “family or friends”; however, additional categories can be employed. Furthermore, importance level categories are not limited to “high”, “middle” and “low”, and can be further divided to provide more levels. In addition, a user can arbitrarily designate the number of categories and their contents, and can, for example, be notified of the value of the probability “high”. Either this, or the user may be notified of the individual values of the probabilities “high”, “middle” and “low” obtained by weighting. In these cases, the discrete categories can be extended to continuous categories. When probability determinations are made for multiple email messages that are then displayed at the same time, these email messages can also be sorted and displayed in the descending order of the values of the probabilities or of the values obtained by weighting the probabilities. That is, the continuous values, such as the values of probabilities belonging to specific importance level categories and the values obtained by weighting performed for probabilities belonging to the individual importance level categories, can be employed to evaluate the importance level.

Further, in this embodiment, as information stored in the importance level category determination reference database 204, probabilities for the importance level categories are calculated relative to a set consisting of information indicating whether a keyword for conference is included in the main body of an email message and of information concerning a sender category. However, the probabilities for the importance level categories can be calculated by employing many more conditions.

The entire disclosure of Japanese Patent Application No. 2005-054500 filed on Feb. 28, 2005 including specification, claims, drawings and abstract is incorporated herein by reference in its entirety.

What is claimed is:

1. An information processing system comprising:
a sender information holding unit that stores an email address of a sender of an email in correlation with one of a plurality of sender categories; and
an importance level estimation unit that determines, for each of the plurality of sender categories, importance levels of emails having sender addresses that belong to each of the plurality of sender categories from a plurality of importance level categories, while employing information of emails previously received by a user, and designates the importance levels in correlation with the sender categories;
wherein information of the importance level categories obtained by the importance level estimation unit is subjected to a predetermined process.

2. The information processing system according to claim 1, wherein the importance level estimation unit employs Bayesian statistics or Bayesian networks to determine the importance levels of the emails.

3. The information processing system according to claim 1, further comprising:
a sender classification unit that classifies the email address of the sender into one of the plurality of sender categories, while employing the information of emails previously transmitted/received by the user.

4. The information processing system according to claim 3, wherein, for classifying the email address of the sender, the sender classification unit employs the information of the emails previously transmitted/received by the user and the sender, while weighting using a transmission/reception date.

5. The information processing system according to claim 1, further comprising:
a monitoring unit that monitors a reaction of the user with respect to an email; and
an importance level evaluation unit that evaluates an importance level of the email by using information, obtained by the monitoring unit, reflecting the reaction of the user;
wherein the importance level estimation unit determines the importance level based on results obtained by the importance level evaluation unit.

6. An information processing method performed by an information processing system, which includes a sender information holding unit that stores an email address of a sender of an email in correlation with one of a plurality of sender categories, the method comprising:
determining, for each of the plurality of sender categories, importance levels of emails having sender addresses that belong to each of the plurality of sender categories from a plurality of importance level categories, while employing information of emails previously received by a user; and
designating the importance levels in correlation with the sender categories;
wherein information of the importance level categories thus obtained is subjected to a predetermined process.

7. A storage medium readable by a computer, the storage medium storing a program of instructions executable by the computer, which includes a sender information holding unit that stores an email address of a sender of an email in correlation with one of a plurality of sender categories, to perform a function comprising:
determining, for each of the plurality of sender categories, importance levels of emails having sender addresses that belong to each of the plurality of sender categories from a plurality of importance level categories, while employing information of emails previously received by a user; and
designating the importance levels in correlation with the sender categories;
wherein information of the importance level categories thus obtained is subjected to a predetermined process.
